(19) United States
(12) Patent Application Publication
(10) Pub. No.: US 2006/0225487 A1
(43) Pub. Date: Oct. 12, 2006

(54) Environment detector with a four-in-one probe

(76) Inventor: Dong-Chang Lin, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/102,691

(22) Filed: Apr. 11, 2005

(51) Int. Cl. G01N 7/00

(52) U.S. Cl. 73/29.01

(57) ABSTRACT

The invention relates to an environment detector with a four-in-one probe having functions for detecting humidity, temperature, light, and wind speed of environment. The probe includes a connecting wire and a connecting head to engage with a connecting receiver formed on the detector for electrical connection, while the probe can be placed independently in environment being detected. Hence, the data of the environment can be read from the panel of the detector easily and efficiently.

### FIELD OF THE INVENTION

The present invention relates to an environment detector with a four-in-one probe, which includes a connecting wire to engage with the detector and is useful to detect factors, such as humidity, temperature, light, and wind speed of environment more conveniently.

### BACKGROUND OF THE INVENTION

It is sometimes necessary to detect factors, such as humidity, temperature, light, and wind speed of environment. There are some known apparatus to detect the environment factors including:
1. Single or few functional apparatus, which has its probe jointed with the apparatus or being separated.
2. Multi-functional assembled apparatus with connected probe as a single object.
   In order to provide an assembled apparatus with multiple functions, which can detect several factors of environment more quickly and conveniently, the single detector has been designed, such as the said point 2, the apparatus with connected probe. But this kind of apparatus including the probe jointed on the apparatus is not suitable for detecting in some special environment, where the user will not feel easy. Since the data is shown on the detector, which must be placed in such environment together with the probe, it is hard and uneasy to read the data.

### SUMMARY OF THE INVENTION

The present invention is to provide an environment detector with a four-in-one probe, which includes a separated probe with a connecting wire for engaging with the detector, while the probe can be placed independently in any environment. Now, accompanying with the following drawings, the character of the present invention will be described here and after.

### BRIEF DESCRIPTION OF THE DRAWINGS

FIG. 1 is an assembled perspective view showing an environment detector with a four-in-one probe according to the present invention.

FIG. 2 is an exploded perspective view showing an environment detector with a four-in-one probe according to the present invention.

### DETAILED DESCRIPTION OF THE PREFERRED EMBODIMENT

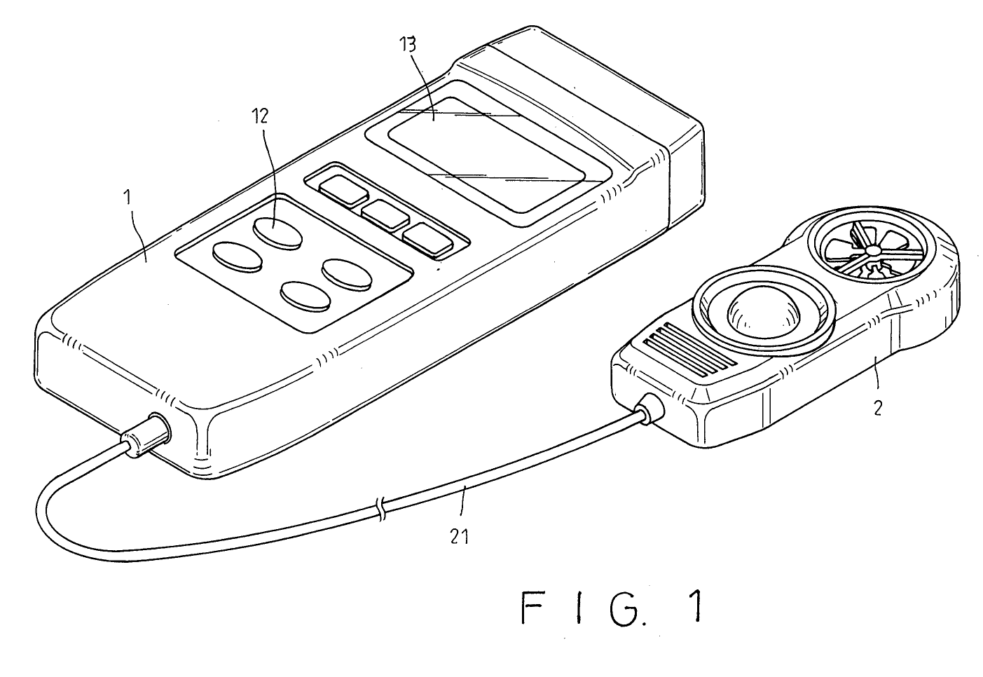

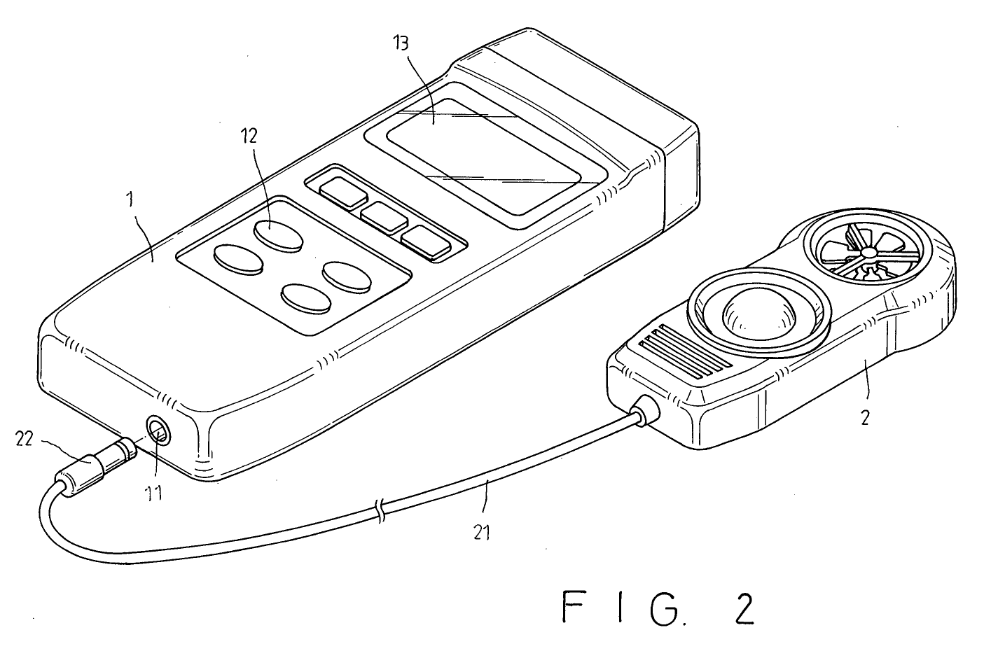

The present invention relates to an improvement of an environment detector for detecting environment factors more conveniently. Please refer to FIGS. 1 and 2, this invention includes a separated detector (1) and a four-in-one probe (2) for detecting factors including humidity, temperature, light, and wind speed of environment. The probe (2) includes a connecting wire (21) and a connecting head (22), which can be engaged within a connecting receiver (11) formed on the detector (1) for electrical connection.

When to detect any factor of the environment, the four-in-one probe (2) can be placed independently therein. The user can control buttons (12) on the detector (1) and reads all data from panel (13), including humidity, temperature, light, and wind speed of environment. Hence, the user is not necessary to enter any specific environment and can obtain all information that makes the huge progress.

Another advantage of the present invention is that the detector (1) is not placed in detected environment. Hence, the detector will not be affected to obtain an accurate data. Moreover, the detector (1) will not be damaged by terrible environment.

Accordingly, the present invention is obviously utilized and effective. It should be allowed for patent.

I claim:

1. An environment detector with a four-in-one probe including a detector and a four-in-one probe, wherein the probe includes a connecting wire and a connecting head to engage with a connecting receiver formed on the detector for electrical connection, while the probe can be placed independently in environment being detected.

2. An environment detector with a four-in-one probe as claimed in claim 1, wherein the probe is provided with functions for detecting humidity, temperature, light, and wind speed of environment.
